(19) United States
(12) Patent Application Publication
(10) Pub. No.: US 2018/0029529 A1
(43) Pub. Date: Feb. 1, 2018

(54) TURN LAMP

(71) Applicant: MURAKAMI CORPORATION, Shizuoka (JP)

(72) Inventors: Kota ISEKI, Shizuoka-city (JP); Hiroaki NAGANO, Yaizu-city (JP)

(73) Assignee: MURAKAMI CORPORATION, Shizuoka (JP)

(21) Appl. No.: 15/552,104

(22) PCT Filed: Feb. 4, 2016
(86) PCT No.: PCT/JP2016/053359

§ 371 Date: Aug. 18, 2017

(30) Foreign Application Priority Data
Feb. 26, 2015 (JP) 2015-036431

(51) Int. Cl. B60Q 1/34; F21V 14/04; F21S 8/10

(52) U.S. Cl. CPC B60Q 1/34; F21S 48/232; F21S 48/2212; F21V 14/04; F21S 48/24; F21S 48/215; F21S 48/212; F21Y 2115/10

(57) ABSTRACT

The present invention prevents deterioration in design of a turn lamp by a reflected image of lens cuts of a light-guiding lens. A turn lamp includes a light-guiding lens, a mirror surface disposed behind the light-guiding lens, and a light source that causes light to enter light-guiding lens. The light-guiding lens includes lens cuts formed so as to extend in a light-guiding direction thereof. A mirror surface includes a recess surface formed behind the lens cuts along the lens cuts. The recess surface is formed so as to have a width in a short direction thereof, the width being larger than a width in a short direction of the lens cuts.

### TECHNICAL FIELD

This invention relates to a turn lamp to be mounted in a vehicle, deterioration in design of the turn lamp by a reflected image of lens cuts in a light-guiding lens being prevented.

### BACKGROUND ART

As turn lamps for a vehicle, there are ones described in below-indicated Patent Literatures 1 and 2. These turn lamps will be described. Reference numerals in parentheses are reference numerals used in Patent Literatures 1 and 2. The turn lamp described in Patent Literature 1 includes a light-guiding lens (40), an aluminum vapor-deposited sheet (50) disposed on the periphery and the rear side of the light-guiding lens (40) as viewed from the viewpoint side from which the turn lamp is viewed, and a light source (30) that causes light to enter the light-guiding lens (40). In the vicinity of a light exit surface (42) on an end in a light-guiding direction of a rear surface of the light-guiding lens (40), reflective steps (43) are formed. Light emitted from the light source (30) is guided inside the light-guiding lens (40) and is emitted toward the rear side of the vehicle from the light exit surface (42). A part of the light guided through the inside of the light-guiding lens (40) is reflected by the reflected steps (43) and emitted toward the front side and the lateral side of the vehicle. An insertion portion (52) of the aluminum vapor-deposited sheet (50), the insertion portion being disposed on the rear side of light-guiding lens (40) as viewed from the viewpoint side from which the turn lamp is viewed, reflects light leaked rearward from the reflective steps (43) of the light-guiding lens (40) forward. The forward reflection enhances an efficiency of use of the turn lamp light and thus the turn lamp light is emitted brightly.

The turn lamp described in Patent Literature 2 includes a light-guiding lens (8), a light-scattering reflective surface (7b) disposed on the rear side of the light-guiding lens (8) as viewed from the viewpoint side from which the turn lamp is viewed, and a light source (6b) that causes light to enter the light-guiding lens (8). The light-scattering reflective surface (7b) is formed in a recess of an inner housing (7) , and the light-guiding lens (8) occludes an opening of the recess. A surface of the light-guiding lens (8) is textured, and a light-scattering surface (8a) is thereby formed on the surface. Light emitted from the light source (6b) is reflected so as to scatter by the light-scattering reflective surface (7b), and is further scattered by the light-scattering surface (8a) and passes through the light-guiding lens (8) and is released as uniform and soft light to the external world.

### CITATION LIST

### Patent Literature

Patent Literature 1: Japanese Patent Laid-Open No. 2013-075608
Patent Literature 2: Japanese Patent Laid-Open No. 2010-100080

### SUMMARY OF INVENTION

### Technical Problem

Like, for example, the reflective steps (43) described in Patent Literature 1, a light-guiding lens may have a lens structure or a prism structure each of which is provided by bumps and pits called lens cuts (which are not fine bumps and pits like texture, but are larger bumps and pits). Lens cuts provided to a light-guiding lens has an ornamental function that causes the lens cuts themselves to look luminous by means of turn lamp light or external light as well as a practical function that refracts and reflects turn lamp light in a direction that is different from a light-guiding direction to enable the reflected light to be viewed from the front side or the lateral side of the own vehicle. In a turn lamp including a light-guiding lens provided with lens cuts, if a mirror surface is disposed behind the light-guiding lens, a reflected image from the lens cuts may be reflected on the mirror surface. In this case, at a height position at which the lens cuts are viewed nearly horizontally, the reflected image of the lens cuts on the mirror surface is substantially hidden behind the actual lens cuts and thus unnoticeable. However, upon the height position at which the lens cuts are viewed being moved upward or downward from that position, the reflected image of the lens cuts moves to the upper side or the lower side relative to the actual lens cuts and thereby appears to protrude from the actual lens cuts. As a result, it has been found that the original outline of the lens cut appears to be destroyed (for example, the actual lens cuts and the reflected image thereof appear in two separate lines), which may hinder the ornamental function of the lens cuts. In particular, where a curve of the lens cuts is formed along a curve in a light-guiding direction of the light-guiding lens (curve along a shape of an outer peripheral surface of the mirror body), the curve shape of the actual lens cuts and that of the reflected image of the lens cuts protruding to the upper side or the lower side of the actual lens cuts may look largely different from each other. As a result, it has been found that the original outline of the lens cuts appears to be largely destroyed, which may largely hinder ornamental function of the lens cuts. Such disadvantage occurs both when the turn lamp is on and when the turn lamp is off (when external light is applied).

This invention is intended to solve the aforementioned problem and provide a turn lamp that prevents a reflected image of lens cuts from hindering an ornamental function of the lens cuts and thereby prevents deterioration in design of the turn lamp by the reflected image.

### Solution to Problem

In this invention, where lens cuts are formed in a light-guiding lens along a light-guiding direction of the light-guiding lens, a recess surface is formed in a mirror surface behind the lens cuts along the lens cuts to cause a reflected image of the lens cuts to appear to be held in the recess surface, and thus, even if a position from which the turn lamp is viewed is moved somewhat in a short direction of the lens cuts, the state in which the reflected image of the lens cuts is held in the recess surface is maintained. Accordingly, as a result of the reflected image of the lens cut being held in the recess surface, when a position from which the turn lamp is viewed is moved in the short direction of the lens cuts, movement of the reflected image of the lens cuts in the short direction of the lens cuts relative to the actual lens cuts is suppressed compared to the case where no recess surface is provided. As a result, the ornamental function of the lens cuts is prevented from being hindered and design deterioration by the reflected image of the lens cuts is prevented.

An aspect of a turn lamp according to this invention is a turn lamp for a vehicle, the turn lamp including a light-guiding lens, a mirror surface disposed behind the light-guiding lens as viewed from a viewpoint side from which the turn lamp is viewed, and a light source that causes light to enter the light-guiding lens, wherein: the light-guiding lens includes a lens cut formed so as to extend in a light-guiding direction of the light-guiding lens; the mirror surface includes a recess surface formed behind the lens cut as viewed from the viewpoint side, along the lens cut; and the recess surface is formed so as to have a width in a short direction thereof, the width being larger than a width in a short direction of the lens cut, as viewed from the viewpoint side. Accordingly, the recess surface is formed in the mirror surface disposed behind the lens cut along the lens cut, so as to have a width larger than that of the lens cut, and thus, a reflected image of the lens cut expands in the width direction of the recess surface and appears to be held in the recess surface. Thus, even if a position from which the turn lamp is viewed is moved somewhat in the short direction of the lens cut, the reflected image of the lens cut still remains in the recess surface. Therefore, movement of the reflected image of the lens cut in the short direction of the lens cut relative to the actual lens cut is suppressed compared to the case where no recess surface is provided. As a result, the ornamental function of the lens cut is prevented from being hindered by the reflected image, and deterioration in design of the turn lamp by the reflected image is prevented. Also, the recess surface of the mirror surface is formed so as to have a width larger than that of the lens cut, the image of the lens cut reflected by the recess surface can be made to appear to protrude outward in the width direction of the actual lens cut. As a result, the reflected image can be made to appear on opposite sides in the width direction of the actual lens cut, a three-dimensional appearance of the lens cut is provided by the actual lens cut and the reflected image, Even if the image reflected by the recess surface appears on the opposite sides in the width direction of the actual lens cut like this, when the position from which the turn lamp is moved in the short direction of the lens cut, movement of the reflected image of the lens cut in the short direction of the lens cut relative to the actual lens cut is suppressed, which prevents the ornamental function of the lens cut from being hindered and also prevents deterioration in design by the reflected image of the lens cut. An amount of outward protrusion in the width direction of the actual lens cut of the image of the lens cut reflected by the recess surface can arbitrarily be set. More specifically, the protrusion amount can be set as, for example, preferably 0.1 to 5 mm on each of the opposite sides in the short direction of the lens cut, more preferably 0.5 to 2 mm on each of the opposite sides. In an embodiment described later, the protrusion amount is set as, for example, 1 mm on each of the opposite sides. Note that in the turn lamp described in Patent Literature 1, an aluminum vapor-deposited surface provided by the insertion portion (52) disposed behind the light-guiding lens (40) as viewed from the viewpoint side from which the turn lamp is viewed is a flat surface, not a recess surface. Also, the recess surface (7b) of the turn lamp described in Patent Literature 2 is a light-scattering reflective surface, not a mirror surface, and in addition, the surface (8a) of the light-guiding lens (8) is a textured light-scattering surface, and is not provided with lens cuts.

As another aspect of this invention, the light-guiding lens includes an auxiliary lens at each of outer-side positions on opposite sides in the short direction of the lens cut as viewed from the viewpoint side, along the lens cut, and the auxiliary lens is provided with no lens cut or is provided with a lens cut that causes less attenuation in the light-guiding direction compared to the lens cut, Accordingly, an end face in a short direction of the light-guiding lens is prevented from appearing just outside each of the opposite sides in the short direction of the lens cut, and thus, it is possible to make the lens cut conspicuous and thereby make the lens cut look good.

As still another aspect of this invention, the auxiliary lens includes a light entrance from which the light from the light source enters, and a light exit from which the light entered from the light entrance and guided through the auxiliary lens is emitted. Accordingly, since the auxiliary lens is provided with no lens cut or is provided with a lens cut that causes less attenuation in the light-guiding direction, it is possible that light entered from the light entrance is efficiently guided with less attenuation and emitted from the light exit to emit bright turn lamp light toward the rear side of the vehicle. Also, consequently, flexibility in design of the light-guiding lens can be ensured.

As still another aspect of this invention, the mirror surface includes an auxiliary reflective surface disposed so as to extend at each of positions on opposite outer sides in the short direction of the lens cut as viewed from the viewpoint side, at least a part of the lens cut is disposed on a front side relative to the auxiliary reflective surfaces as viewed from the viewpoint side, and the auxiliary reflective surfaces include respective surfaces inclined outward relative to each other in the short direction of the lens cut. Here, “inclined outward relative to each other” means inclination in a direction in which the back sides of the respective surfaces face each other, and is an antonym of “inclined inward relative to each other”, which means inclination in a direction in which the respective surfaces face each other. Accordingly, appearance of the reflected image of the lens cut on the part of the mirror surface at each of outer positions on opposite sides in the short direction of the recess surface can effectively be suppressed and thus, it is possible to make the actual lens cut appear to be conspicuous.

As still another aspect of this invention, the recess surface is a curved surface. Accordingly, the reflected image of the lens cut is enlarged in the short direction of the lens cut by the curved surface, and the actual lens cut and the enlarged reflected image overlap each other, and thus, it is possible to make a distinctive lens cut pattern appear.

### BRIEF DESCRIPTION OF DRAWINGS

FIG. 1 is a diagram of an end face of the turn lamp in FIG. 3 cut at the position indicated by arrows B-B, and illustrates a posture of the turn lamp when the turn lamp is mounted in a mirror body and the mirror body is in a used position.

FIG. 2 is a back surface view of the door mirror for the right side of a vehicle including the turn lamp in FIG. 3 (the back surface is a surface facing the front side of the vehicle when the mirror body is in the use position).

FIG. 3 is a front view illustrating an embodiment of a turn lamp according this invention and illustrates a reference posture of the turn lamp alone.

FIG. 4 is an exploded perspective view of the turn lamp in FIG. 3.

FIG. 5 is a diagram of an end face of the turn lamp in FIG. 3 cut at the position indicated by arrows A-A.

FIG. 6 is an enlarged view of a part of a lens cut indicated by C in FIG. 3.

FIG. 7A is a front view illustrating a photograph of an actual product of the turn lamp in FIG. 3 (illustrated with an outer cover removed).

FIG. 7B is an enlarged partial front view illustrating a photograph of the actual product of the turn lamp in FIG. 7A (illustrated with an outer cover removed).

FIG. 7C is an enlarged partial front view illustrating a photograph of the actual product of the turn lamp in FIG. 7A as viewed from a position above that in FIG. 7B (illustrated with an outer cover removed).

FIG. 8A is a front view illustrating a photograph taken of a light-guiding lens in the actual product of the turn lamp in FIG. 7A with a silver tape attached to an entire back surface thereof (illustrated with an outer cover removed) as a comparative example for the turn lamp in FIG. 7A.

FIG. 8B is an enlarged partial front view illustrating a photograph of the actual product of the turn lamp in FIG. 8A (illustrated with an outer cover removed).

FIG. 8C is an enlarged partial front view illustrating a photograph of the actual product of the turn lamp in FIG. 8A as viewed from a position above that in FIG. 8B (with an outer cover removed).

FIG. 9 is a diagram illustrating another embodiment of a shape of a recess surface and is a diagram of an end face cut at a position that is the same as that in FIG. 1,

FIG. 10 is a diagram illustrating still another embodiment of the shape of the recess surface and is a diagram of an end face cut at a position that is the same as that in FIG. 1.

FIG. 11 is a diagram illustrating another embodiment of a position at which a mirror surface is disposed and is a diagram of an end face cut at a position that is the same as that in FIG. 1.

### DESCRIPTION OF EMBODIMENTS

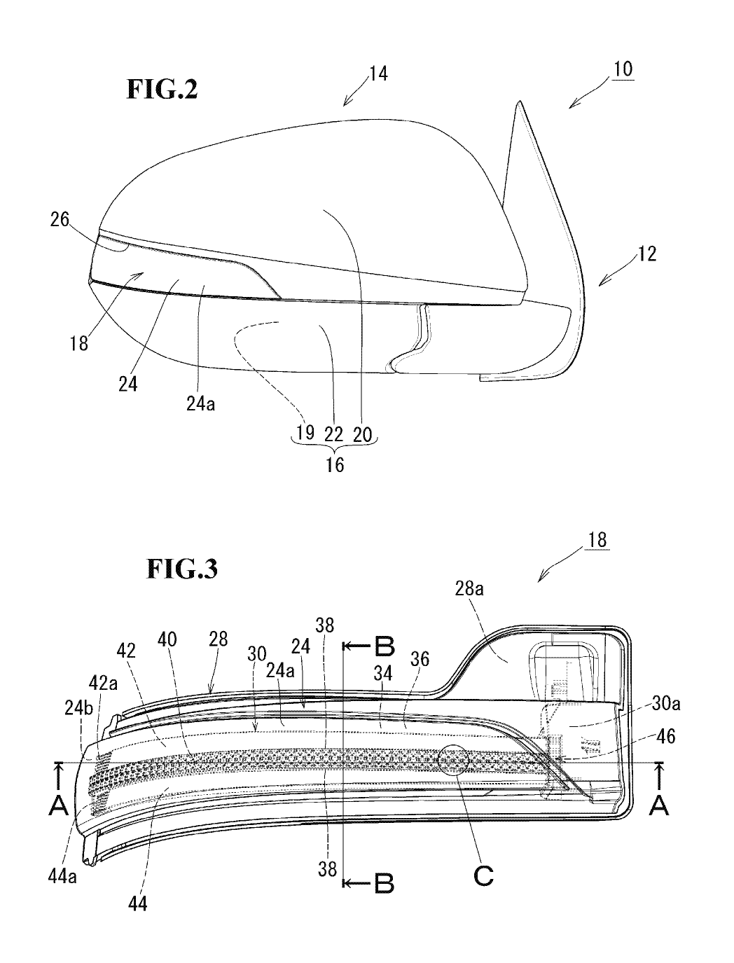

Embodiments of this invention will be described below. FIG. 2 illustrates a door mirror 10 for the right side of a vehicle, in which a turn lamp according this invention is mounted. The door mirror 10 includes a mirror base 12 fixed to a body of the vehicle (right door, which is not illustrated) and a mirror body 14 pivotally attached to and supported by the mirror base 12 so as to be movable between a use position and a stored position. The mirror body 14 includes a mirror housing 16 in which a frame, an electric storing unit and a mirror surface angle adjustment actuator supported by the frame, a mirror holder supported by the mirror surface angle adjustment actuator in such a manner that a mirror surface angle is adjustable, a mirror plate fixedly held by the mirror holder (which are all not illustrated), and a turn lamp 18 are housed and disposed, The mirror housing 16 includes a visor 19, an upper cover 20 and a lower cover 22. The visor 19 forms a front surface (surface facing the rear side of the vehicle when the mirror body 14 is in the use position) side of the mirror housing 16, and allows the mirror plate held by the mirror holder to be received and thus disposed in a recess that opens to the front surface side, The upper cover 20 and the lower cover 22, which form an outer contour of the mirror housing 16, are covered on and thus fitted to the back side of the visor 19. The upper cover 20 forms an upper part of the outer contour, and the lower cover 22 forms a lower part of the outer contour. In an upper area of the lower cover 22, an opening 26 for causing an outer cover 24 of the turn lamp 18 to be exposed to the external world is formed as a cutout. The opening 26 horizontally extends continuously from a back surface (surface facing the front side of the vehicle where the mirror body 14 is in the use position) of the mirror housing 16 to a side surface (surface facing the lateral side of the vehicle when the mirror body 14 is in the use position) of the mirror housing 16. The turn lamp 18 is screwed and thus fitted to the back surface of the visor 19 and then the lower cover 22 is put on and thus fitted to a lower part of the back surface of the visor 19, and subsequently, the upper cover 20 is put on and thus fitted to an upper part of the back surface of the visor 19, whereby the mirror housing 16 is assembled to the mirror body 14. At this time, a projection 24a of the outer cover 24 of the turn lamp 18 is exposed to the external world from the opening 26. The outer cover 24 is formed so as to horizontally curve along a curved surface of the mirror housing 16. Turn signal light emitted from an exposed surface of the turn lamp 18 can be viewed from a whole area ranging from the front side to the rear right side of the vehicle.

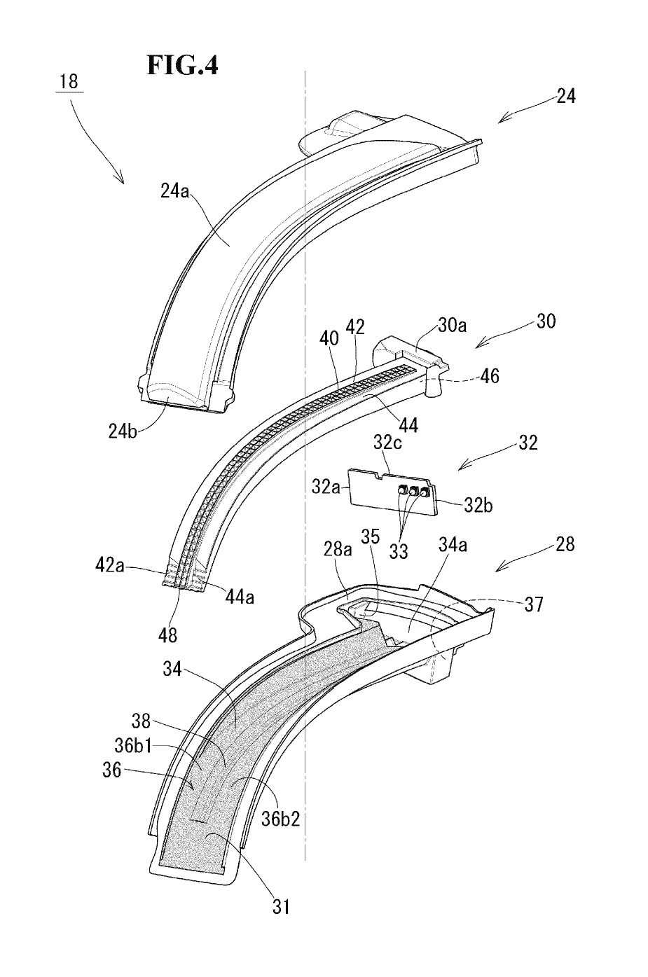

The turn lamp 18 will be described. FIG. 3 is a front view of the turn lamp 18 alone, and FIG. 4 is an exploded perspective view of the turn lamp 18. Components of the turn lamp 18 will be described based on FIG. 4. The turn lamp 18 includes a lamp housing 28 formed of a non-transparent plastic material, and a light-guiding lens 30 and the outer cover 24 each formed of a transparent plastic material such as a PMMA resin. The lamp housing 28 forms a holding portion of the light-guiding lens 30. The outer cover 24 forms a cover of the light-guiding lens 30.

A front surface of the lamp housing 28 is formed in a horizontally-long, substantially rectangular shape. The lamp housing 28 curves in a long direction (longitudinal direction) thereof along the curved surface of the mirror housing 16 and is formed continuously from a surface facing the front side of the vehicle to a surface facing the lateral side of the vehicle when the mirror body 14 is in the use position. An end of the lamp housing 28, the end being close to the body of the vehicle, bulges in a short direction (upper-lower direction when mounted on the vehicle) and thus forms a bulge 28a for disposing a circuit board 32. In the front surface (surface facing toward the viewpoint side from which the turn lamp 18 is viewed) of the lamp housing 28, a recess 34 for receiving the light-guiding lens 30 is formed along the long direction (substantially the horizontal direction when mounted on the vehicle) thereof. A reflective film 31 of a metal such as aluminum or chromium is formed on a surface of the recess 34 by means of, e.g., vapor deposition or plating, and the surface thereby forms a continuous mirror surface 36. In FIG. 4, the fine dotted area of the front surface of the lamp housing 28 (area that looks grey) is the mirror surface 36, In a center in a short direction of the recess 34. a recess surface 38 is formed along a long direction of the recess 34. The recess surface 38 is a surface including an opening, a width in a short direction of the opening is large on the entrance side of the opening and narrowed on the deep side of the opening, and here, the recess surface 38 is formed of a curved surface that curves in a short direction thereof. The width in the short direction of the entrance of the opening of the recess surface 38 and a depth of the opening are roughly constant in a long direction of the recess surface 38. The entire recess surface 38 is formed within an area of the mirror surface 36, and the mirror surface 36 is formed continuously by the recess surface 38 and surfaces on opposite outer sides in the short direction of the recess surface 38 (auxiliary reflective surfaces 36b1 and 36b2 described later).

The light-guiding lens 30 has a flat plate-like shape, and a front shape of the light-guiding lens 30 is formed in an elongated shape having a long direction and a short direction. The long direction is a light-guiding direction. The light-guiding lens 30 curves in the long direction thereof along the lamp housing 28 and is formed continuously from a surface facing the front side of the vehicle to the lateral side of the vehicle when the mirror body 14 is in the use position. No texture or the like is formed at a peripheral face of the light-guiding lens 30, and thus the entire light-guiding lens 30 can be seen through. In a center in a short direction of the front surface of the light-guiding lens 30, a multitude of lens cuts 40 is formed in a strip along the long direction of the light-guiding lens 30 so as to have a width, a height and a pitch that are constant through a substantially entire length in the long direction of the light-guiding lens 30. The lens cuts 40 curve in a long direction thereof along the light-guiding lens 30 and are formed continuously from a surface facing the front side of the vehicle to a surface facing the lateral side of the vehicle when the mirror body 14 is in the use position. In the light-guiding lens 30, auxiliary lenses 42, 44 are formed adjacent to each other on opposite sides of the lens cuts 40 with the lens cuts 40 interposed therebetween in the short direction. In respective front surfaces of the auxiliary lenses 42, 44, step-like lens cuts (reflective steps) 42a, 44a are formed in the vicinities of respective ends, on the side far from the body of the vehicle, of the auxiliary lenses 42, 44. In the auxiliary lenses 42, 44, no lens cuts other than the reflective steps 42a, 44a are formed. An entire end face of an end close to the body of the vehicle of the light-guiding lens 30 forms a light entrance 46 for turn lamp light. An end face of the end, on the side far from the body of the vehicle, of the light-guiding lens 30 forms a light exit 48 for turn lamp light.

A front shape of the outer cover 24 is horizontally song and is formed in a substantially rectangular shape having a size that is substantially the same as that of the lamp housing 28. The outer cover 24 curves in a long direction thereof along the lamp housing 28 and is formed continuously from a surface facing the front side of the vehicle to a surface facing the lateral side of the vehicle when the mirror body 14 is in the use position. In a center in a short direction of the outer cover 24, a projection 24a is formed along the long direction. The projection 24a is exposed to the external world from the opening 26 (FIG. 2) of the mirror housing 16.

On the circuit board 32, e.g., three LEDs 33, which serve as a light source that emit turn lamp light, a drive circuit (not illustrated) for the LEDs 33 and a female connector (not illustrated) for connecting the drive circuit to an external wiring of the turn lamp 18 are mounted. In the lamp housing 28, an opening (not illustrated) is formed at a position where an insertion port of the female connector faces. A male connector (provided with a waterproof rubber seal) attached to an end of the external wiring is inserted into the insertion port of the female connector from the opening, and both connectors are thereby joined to each other.

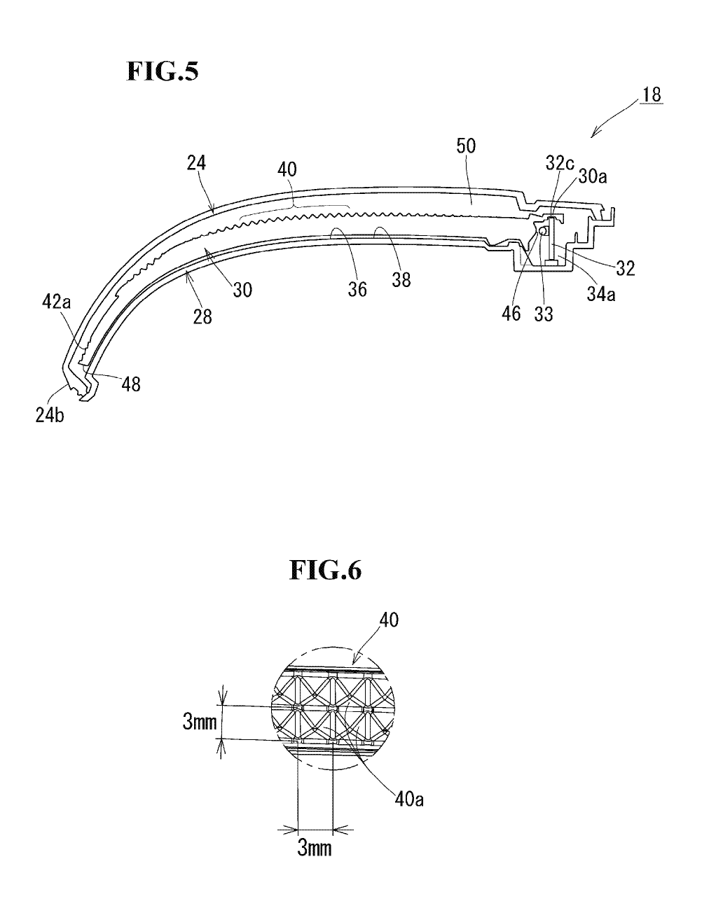

A procedure for assembling the turn lamp 18 will be described. First, the circuit board 32 is put and thereby disposed in a part 34a of the recess 34 of the lamp housing 28, the part 34a being present in the bulge 28a. This putting and disposing action is performed by inserting and dropping opposite sides 32a, 32b of the circuit board 32 into respective slits (not illustrated) formed so as to extend in a depth direction in opposed wall surfaces 35, 37 in the recess 34a. Consequently, the circuit board 32 is supported by both slits and is received and disposed inside the recess 34a in a standing manner. At this time, the LEDs 33 face a direction in which the recess 34 extends (light-guiding direction). Next, the light-guiding lens 30 is put and disposed in the recess 34 of the lamp housing 28. At this time, the light-guiding lens 30 is positioned and fixed at a predetermined position in the recess 34 via non-illustrated claw engagement, Also, at this time, a back surface of a canopy 30a formed at an upper part of an end close to the body of the vehicle of the light-guiding lens 30 is brought into abutment with an upper side 32c of the circuit board 32 (see FIG. 5) and the canopy 30a pushes the circuit board 32 down and thereby fixes the circuit board 32 inside the recess 34a. As a result, the three LEDs 33, 33, 33 face respective positions in the light entrance 46 of the light-guiding lens 30, the positions corresponding to the auxiliary lens 42, the lens cut 40 and the auxiliary lens 44, respectively. Next, the outer cover 24 is put on the lamp housing 28. Consequently, entire peripheral edges of the lamp housing 28 and the outer cover 24 are brought into abutment with each other. The entire peripheries of the abutment surfaces are fused (welded) or bonded to each other, the entire peripheral edges of the lamp housing 28 and the outer cover 24 are thereby joined, and thus, the turn lamp 18 is assembled as a single piece and thus the assembling is completed.

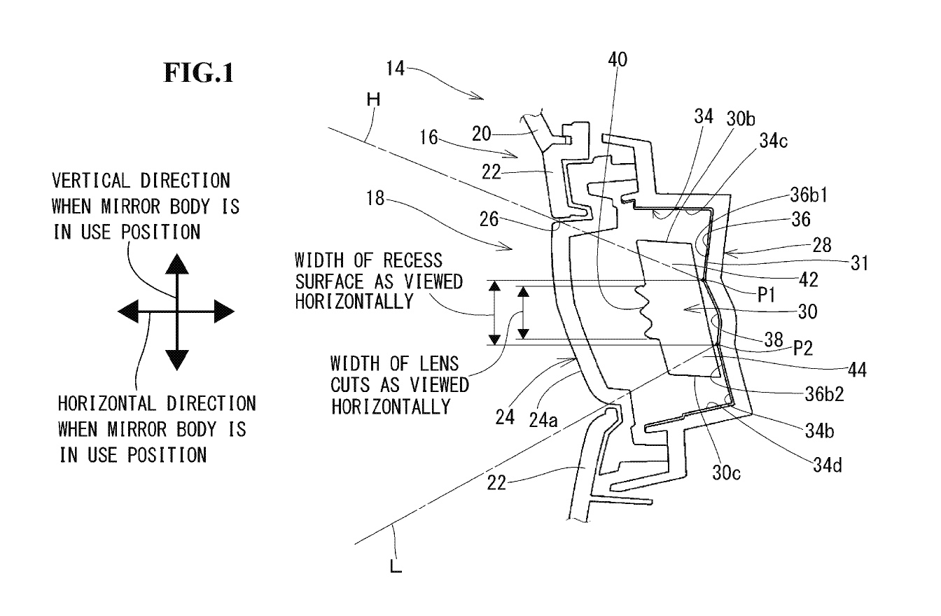

FIG. 3 is a front view of the turn lamp 18 assembled as a single piece as described above. Also, FIG. 5 illustrates an end face cut at the position indicated by arrows A-A in FIG. 3, FIG. 1 illustrates an end face cut at the position indicated by arrows B-B in FIG. 3, and FIG. 6 is an enlarged view of a part of the lens cuts 40 indicated by C in FIG. 3. Note that FIG. 3 illustrates not a posture of the turn lamp 18 when mounted in the mirror body 14, but a reference posture of the turn lamp 18 alone in which the three LEDs 33 (not illustrated in FIG. 3) arranged vertically and a board surface of the circuit board 32 is disposed in a direction perpendicular to the sheet of FIG. 3. In this reference posture, a surface of the canopy 30a at the end close to the body of the vehicle of the light-guiding lens 30 is in parallel with the sheet of FIG. 3. On the other hand, FIG. 1 illustrates a posture of the turn lamp 18 when the turn lamp 18 is mounted in the mirror body 14 and the mirror body 14 is in the use position. The upper-lower direction in FIG. 1 is a vertical direction when the mirror body 14 is in the use position, and the right-left direction is a horizontal direction when the mirror body 14 is in the use position. In the posture in the use position in FIG. 1, a direction in which the three LEDs 33 (not illustrated in FIG. 1) are arranged in a direction somewhat inclined forward relative to the vertical direction as viewed horizontally from the front side of the turn lamp 18 (front side of the vehicle). Likewise, as illustrated in FIG. 1, a plate face of an area of an entire area in an extending direction of the light-guiding lens 30, the area facing the front side of the vehicle, is in a posture somewhat inclined forward relative to the vertical direction.

In the lens cuts 40 in FIG. 6, each lens cut 40a is formed of a prism lens formed by a recess surface having a four-sided pyramid shape (inverse pyramid shape) having a front surface of 3 mm square. The lens cuts 40 are formed by arranging the lens cuts 40a in two, upper and lower, rows, in a knurling pattern continuously over a substantially entire length in the light-guiding direction of the light-guiding lens 30. An inner space 50 (FIG. 5) of the turn lamp 18 is hermetically sealed from the external world except the above-described opening for insertion of the male connector, the opening being formed in the lamp housing 28. The light-guiding lens 30 and the circuit board 32 are received and fixed and thereby disposed in the inner space 50. As illustrated in FIG. 5, the three LEDs 33 all face the light entrance 46 of the light-guiding lens 30 and emit turn lamp light simultaneously. Turn lamp light emitted from the LEDs 33 enters the light entrance 46, is guided inside the light-guiding lens 30 and emitted from the light exit 48, and passes through a distal end face 24b of the projection 24a of the outer cover 24 and is radiated toward the rear side of the vehicle. The radiated light can be viewed from the rear side of the own vehicle. A part of light emitted from a center LED 33 from among the three LEDs 33 hits respective positions in the extending direction of the lens cuts 40, and is reflected and refracted and thereby diffuses during the light being guided inside the light-guiding lens 30. and emitted to the outside of the light-guiding lens 30 from the respective positions. The light can be viewed from the front side and the lateral side of the own vehicle. Light emitted from two LEDs 33 on opposite, upper and lower, sides from among the three LEDs 33 is generally guided through the respective auxiliary lenses 42, 44 and emitted from the light exit 48 without being attenuated much during the guiding. Consequently, bright turn lamp light is emitted toward the rear side of the vehicle.

The cut end face structure in FIG. 1 will be described, The turn lamp 18 is designed based on an assumption that the turn lamp 18 is viewed from a height that is horizontal to the turn lamp 18 on the front side of the turn lamp 18 when the mirror body 14 is in the use position. Hereinafter, the position of the assumed viewpoint is referred to as “reference viewpoint position”. The recess 34 of the lamp housing 28 includes a bottom surface 34b and opposite wall surfaces 34c, 34d. The mirror surface 36 is formed continuously from the bottom surface 34b to the opposite wall surfaces 34c, 34d. Consequently, the mirror surface 36 formed of the reflective film 31 is disposed behind an entire width in an upper-lower direction (short direction) of the light-guiding lens 30 as viewed from the reference viewpoint position. In a center in an upper-lower direction of the bottom surface 34b, the recess surface 38 is formed so as to extend in a groove-like shape in a direction perpendicular to the sheet of FIG. 1. No other recess surfaces are formed at positions in the bottom surface 34b that are off the light-guiding lens 30 in the upper-lower direction (positions on the outer sides in the upper-lower direction of the recess surface 38). In FIG. 1, the cut end face shape of the recess surface 38 is a substantially circular arc shape or a substantially parabolic curve shape. Surfaces 36b1, 36b2 on opposite, upper and lower, sides, across the recess surface 38, of the mirror surface 36 formed in the bottom surface 34b are arranged so as to extend on opposite outer sides in the upper-lower direction of the lens cuts 40 as viewed from the reference viewpoint position and form respective auxiliary reflective surfaces. Each of the auxiliary reflective surfaces 36b1, 36b2 is formed of a respective surface that is flat in the upper-lower direction. From among the auxiliary reflective surfaces, the upper-side auxiliary reflective surface 36b1 is disposed so as to be inclined upward as viewed from the reference viewpoint position. Also, the lower-side auxiliary reflective surface 36b2 is disposed so as to be inclined downward as viewed from the reference viewpoint position. As a result, the two auxiliary reflective surfaces 36b1, 36b2 are disposed so as to be inclined outward relative to each other in the upper-lower direction. The light-guiding lens 30 is attached to and thereby supported by the lamp housing 28 via the aforementioned non-illustrated claw engagement so as to be somewhat spaced from the bottom surface 34b (in a floated state). As illustrated in FIG. 1, an area of the light-guiding lens 30, the area facing the front side of the vehicle, has a substantially parallelogram shape in vertical cross-section. Consequently, the plate face of the light-guiding lens 30 is in a posture somewhat inclined forward relative to the vertical direction as viewed from the reference viewpoint position, and each of an upper surface 30b and a lower surface 30c forms a substantially-horizontal surface. Since the lens cuts 40 are formed on the front surface side of the light-guiding lens 30, the lens cuts 40 are arranged at a position spaced forward from the mirror surface 36. Thus, if the mirror surface 36 is flat in the upper-lower direction, a reflected image of the lens cuts 40 is seen at a position that is twice the space between the actual lens cuts 40 and the mirror surface 36 away from the actual lens cuts 40, via the mirror surface 36. As a result, when the viewpoint position from which the turn lamp 18 is viewed is moved in the upper-lower direction from the reference viewpoint position, the actual lens cuts 40 and the reflected image thereof move relative to each other in the upper-lower direction by a distance that is twice the distance of the movement in the upper-lower direction of the viewpoint position. Thus, even if the viewpoint position is only slightly moved in the upper-lower direction, the reflected image of the lens cuts 40 moves largely in the upper-lower direction relative to the actual lens cuts 40, and the reflected image appears to protrude largely from the actual lens cuts 40 in the upper-lower direction. As a result, the original outline of the lens cuts 40 appears to be destroyed (for example, the actual lens cut 40 and the reflected image thereof appear in two separate lines). In order to avoid such disadvantageous phenomenon, the recess surface 38 and the auxiliary reflective surfaces 36b1, 36b2 are formed in the mirror surface 36, and the auxiliary reflective surfaces 36b1, 36b2 are disposed adjacent to a top and a bottom of the recess surface 38 so as to be inclined outward relative to each other in the upper-lower direction. The recess surface 38 is formed at a position, at which the recess surface 38 overlaps the lens cuts 40, behind the lens cuts 40 as viewed from the reference viewpoint position, along the lens cuts 40. As viewed from the reference viewpoint position, the recess surface 38 is formed so as to have a width in the upper-lower direction, the width being larger than a width in the upper-lower direction of the lens cuts 40, and an entire area in the extending direction of the lens cuts 40 is disposed within the width in the upper-lower direction of the recess surface 38 and upper and lower parts of the recess surface 38 appear to slightly protrude above and below the actual lens cuts 40 and have widths that are substantially equal to each other. For example, where design is made so that the width in the upper-lower direction of the lens cuts 40 (width as viewed horizontally in FIG. 1) is 5 mm and the width in the upper-lower direction of the recess surface 38 (width as viewed horizontally in FIG. 1) is 7 mm, as viewed from the reference viewpoint position, the recess surface 38 appears to protrude above and below the actual lens cuts 40 by 1 mm for each. An image of the lens cuts 40 is enlarged in the upper-lower direction by the recess surface 38 forming a concave mirror. At this time, as viewed from the reference viewpoint position, the reflected image of the lens cuts 40 appear to be held in the substantially entire width in the upper-lower direction of the recess surface 38, and the reflected image of the lens cuts 40 is not seen in the auxiliary reflective surfaces 36b1, 36b2. As a result, as viewed from the reference viewpoint position, an image in which the actual lens cuts 40 and the reflected image thereof passed through the lens cuts 40 overlap each other is seen in a surface of the actual lens cuts 40, and upper and lower parts of the reflected image appear to slightly protrude above and below the actual lens cuts 40 and have widths that are substantially equal to each other. The recess surface 38 is formed so as to have a width in the upper-lower direction, the width being larger than the width in the upper-lower direction of the lens cuts 40, and as viewed from the reference viewpoint position, the upper-lower direction of the actual lens cuts 40 is held within the width in the upper-lower direction of the recess surface 38, and thus, even if the auxiliary reflective surfaces 36b1, 36b2 are not inclined outward relative to each other in the upper-lower directions (that is, the auxiliary reflective surfaces 36b1, 36b2 are in plane with each other), as viewed from the reference viewpoint position, the reflected image of the lens cuts 40 is not seen in the auxiliary reflective surfaces 36b1, 36b2. Upon the viewpoint position from which the turn lamp 18 is viewed being moved slightly in the upper-lower direction from the reference viewpoint position, the amount of protrusion of the recess surface 38 to the upper side or the lower side of the actual lens cuts 40 slightly increases along with the movement. However, the state in which the reflected image of the lens cuts 40 appears to be held in the substantially-entire width in the upper-lower direction of the recess surface 38 remains unchanged. Therefore, the reflected image of the lens cuts 40 is not seen in the auxiliary reflective surfaces 36b1, 36b2. In particular, the auxiliary reflective surfaces 36b1, 36b2 are inclined outward in the upper-lower direction relative to the horizontal direction, and thus, the reflected image of the lens cuts 40 does not appear on the auxiliary reflective surfaces 36b1, 36b2 unless the viewpoint is moved significantly in the upper-lower direction from the reference viewpoint position. In this way, even if a height position from which the lens cuts 40 are viewed changes from the reference viewpoint position, the state in which the image of the lens cut 40, the image being reflected by the mirror surface 36, is held in the substantially entire width in the upper-lower direction of the recess surface 38 remains unchanged. Therefore, the actual lens cuts 40 and the reflected image thereof move relative to each other in the upper-lower direction only by a distance that is substantially the same as a distance of movement in the upper-lower direction of the viewpoint position, and thus, a large increase in amount of protrusion of the reflected image of the lens cuts 40 from the actual lens cuts 40 is suppressed. Consequently, the ornamental function of the lens cuts 40 is prevented from being hindered (for example, a sufficient distance of movement in the upper-lower direction until the actual lens cuts 40 and the reflected image thereof are separated into two lines can be secured), and thus, deterioration in design by the reflected image of the lens cuts 40 is prevented. Such design deterioration prevention effect can be obtained both when the turn lamp 18 is on and when the turn lamp 18 is off (when external light is applied). Also, although the lens cuts 40 curve along the curve in the light-guiding direction of the light-guiding lens 30 (curve along the shape of the outer peripheral surface of the mirror body), the reflected image of the lens cuts 40 is held in the recess surface 38, and thus, the curve shape of the actual lens cuts 40 and the curve shape of the reflected image thereof are prevented from appearing to be largely different from each other. In this point, also, deterioration in design by the reflected image of the lens cuts 40 is prevented. Note that alternate long and short dash line H in FIG. 1 indicates a limit, as the turn lamp 18 is viewed from a position above the limit, a lower end P1 of the auxiliary reflective surface 36b1 being hidden by the upper side of the mirror housing 16 of the turn lamp 18 and thus being unable to be seen. Likewise, alternate long and short dash line L indicates a limit, as the turn lamp 18 is viewed from a position below the limit, an upper end P2 of the auxiliary reflective surface 36b2 being hidden by the lower side of the mirror housing 16 of the turn lamp 18 and thus being unable to be seen. Therefore, if angles of inclination of the auxiliary reflective surfaces 36b1, 36b2 are set as angles that prevent the reflected image of the lens cuts 40 from appearing on the auxiliary reflective surfaces 36b1, 36b2 when a height position from which the turn lamp 18 is viewed is changed within the range between alternate long and short dash lines L, H, the reflected image of the lens cuts 40 can be prevented from appearing on the auxiliary reflective surfaces 36b1, 36b2 as the turn lamp 18 is viewed from any height position.

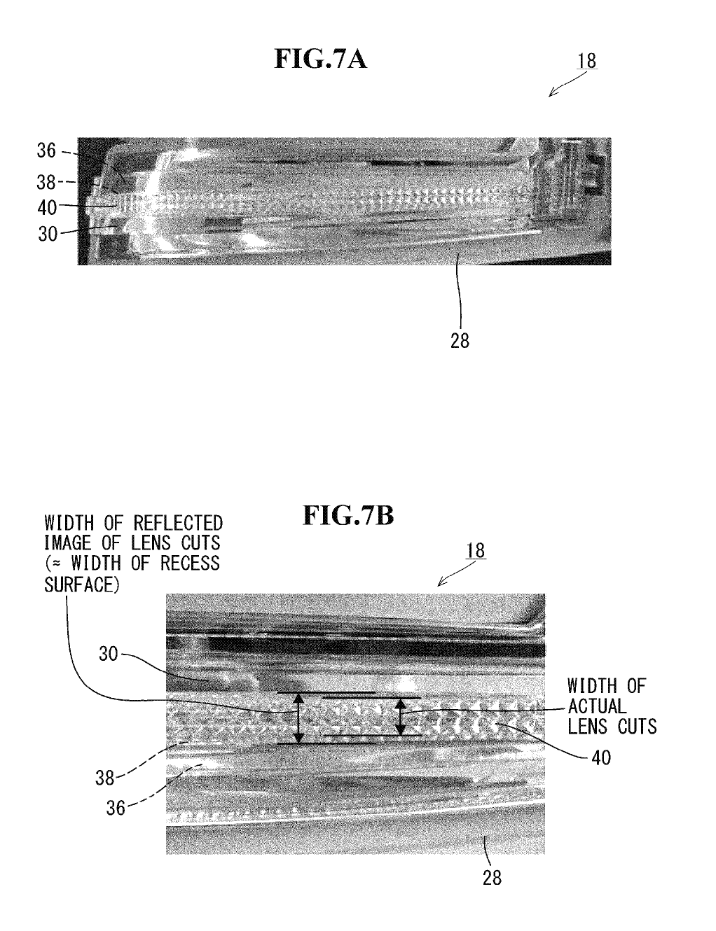

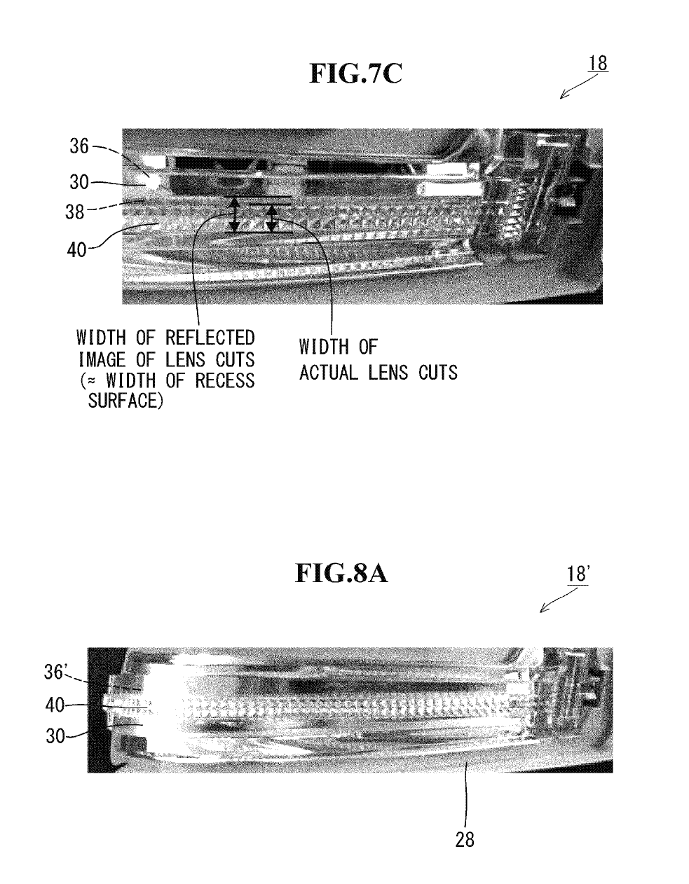

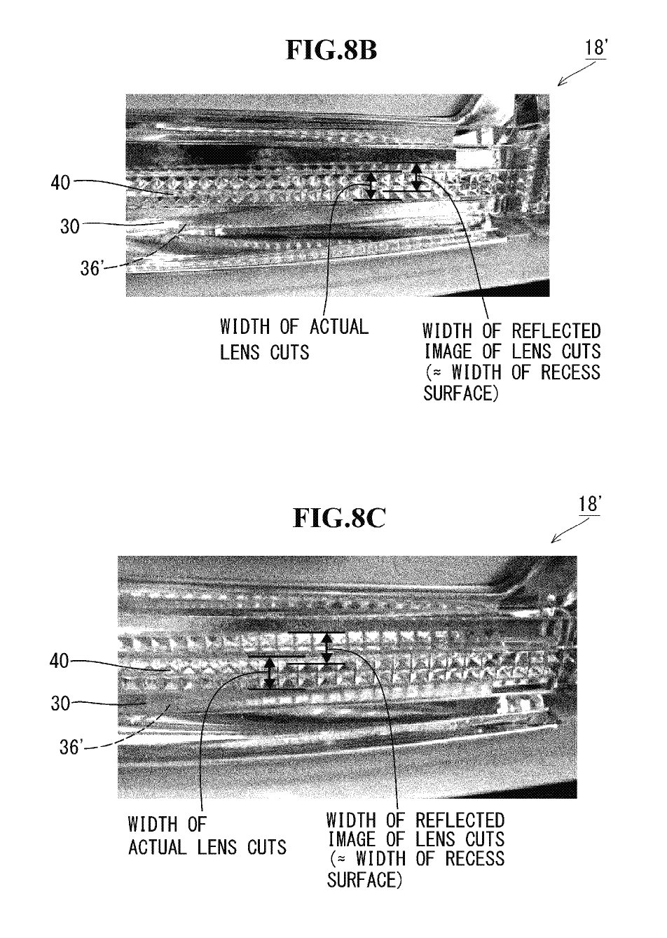

Here, a result of verification of appearances of actual lens cuts 40 and a reflected image thereof using an actual product of the above-described turn lamp 18 will be described together with a comparative example. FIGS. 7 (A, B and C) are photographs each illustrating an appearance of the turn lamp 18, and FIGS. 8 (A, B and C) are photographs each illustrating an appearance of a turn lamp 18′ according to a comparative example. The figures all illustrate an appearance of the turn lamp 18 or 18′ when the turn lamp 18 is off (when external light is applied) , For ease of recognition of the reflected image, these photographs are all taken in a state in which the outer cover 24 is removed. The turn lamp 18′ according to the comparative example in FIG. 8 is provided for confirming how the turn lamp 18 in FIG. 7 looks when no recess surface 38 is provided in the mirror surface 36 of the turn lamp 18 and the auxiliary reflective surfaces 36b1, 36b2 are not inclined relative to each other in the upper-lower direction and are in plane with each other (that is, when an entire area in the upper-lower direction of the mirror surface 36 is in a same plane). For this purpose, in the turn lamp 18′, a silver tape is attached to an entire back surface of the light-guiding lens 30 of the turn lamp 18 and a reflective surface of the silver tape is used as a mirror surface 36′. Except this point, the turn lamp 18′ is the same as the turn lamp 18 in FIG. 7.

First, an appearance of the lens cuts 40 according to the turn lamp 18 in FIG. 7 will be described. FIG. 7A illustrates an appearance of the turn lamp 18 (without the outer cover 24) as viewed from a substantially front, reference viewpoint position, and FIG. 7B is an enlarged partial view thereof. A reflected image is enlarged in the upper-lower direction by the recess surface 38 and is held in the entire width in the upper-lower direction of the recess surface 38. As a result, as illustrated in FIG. 7B, the reflected image of the lens cuts 40 appears to slightly protrude on the upper and lower sides of the actual lens cuts 40. FIG. 7C illustrates an appearance as viewed with the viewpoint moved slightly upward from this state. Since there is a gap between the lens cuts 40 and the mirror surface 36, the upward movement of the viewpoint slightly increases an amount of protrusion of the recess surface 38 on the upper side of the actual lens cuts 40. However, the state in which the reflected image of the lens cuts 40 appears to be held in the entire width in the upper-lower direction of the recess surface 38 remains unchanged, and thus, the increase in amount of protrusion of the reflected image of the lens cuts 40 on the upper side of the actual lens cuts 40 is substantially the same as the increase in amount of protrusion of the recess surface 38 on the upper side of the actual lens cuts 40 (that is, an amount of movement of the viewpoint).

Next, an appearance of lens cuts 40 of the turn lamp 18′ according to the comparative example in FIG. 8 will be described. FIG. 8A illustrates the turn lamp 18′ (without an outer cover 24) as viewed from a substantially front, reference viewpoint position (same position as that in FIG. 7A), and FIG. 8B is an enlarged partial view thereof. Since a plate face of the light-guiding lens 30 is inclined forward as viewed from the reference viewpoint position (see FIG. 1), the reflective surface 36′ formed of the sliver tape attached to the rear surface of the light-guiding lens 30 is also inclined forward. Thus, as illustrated in FIG. 8B, upper and lower parts of the reflected image of the lens cuts 40 appear to slightly protrude on the upper side of the actual lens cuts 40 as viewed from the reference viewpoint position. FIG. 80 illustrates an appearance as viewed from a same position as that in FIG. 70, with the viewpoint moved slightly upward from this state. Since there is a gap between the lens cuts 40 and the mirror surface 36′, the upward movement of the viewpoint increases a height of the protrusion of the reflected image of the lens cuts 40 appearing to protrude from the upper side of the actual lens cuts 40. At this time, a distance between the actual lens cuts 40 and the reflected image thereof is twice the gap between the lens cuts 40 and the mirror surface 36′ (mirror surface formed of the silver tape), and thus, the increase in amount of protrusion of the reflected image of the lens cut 40 on the upper side of the actual lens cuts 40 is twice an amount of the movement of the viewpoint.

As can be seen from comparison between FIG. 7C and FIG. 80, the turn lamp 18 according to the embodiment of this invention includes the recess surface 38 in the mirror surface 36, and thus, the reflected image of the lens cut 40 appears to be held in the entire width in the upper-lower direction of the recess surface 38. Thus, when a height position from which the lens cut 40 is viewed is changed, large movement in the upper-lower direction of the position of the reflected image of the lens cut 40 relative to the actual lens cuts 40 is suppressed. As a result, large increase in amount of protrusion of the reflected image of the lens cut 40 relative to the actual lens cuts 40 is suppressed. Therefore, the ornamental function of the lens cuts is prevented from being hindered and thus deterioration in design by the reflected image of the lens cuts is prevented. In addition, since the auxiliary reflective surfaces 36b1, 36b2 are inclined outward in the upper-lower direction relative to the horizontal direction, the reflected image of the lens cuts 40 does not appear on the auxiliary reflective surfaces 36b1, 36b2 unless the viewpoint is moved significantly in the upper-lower direction from the reference viewpoint position.

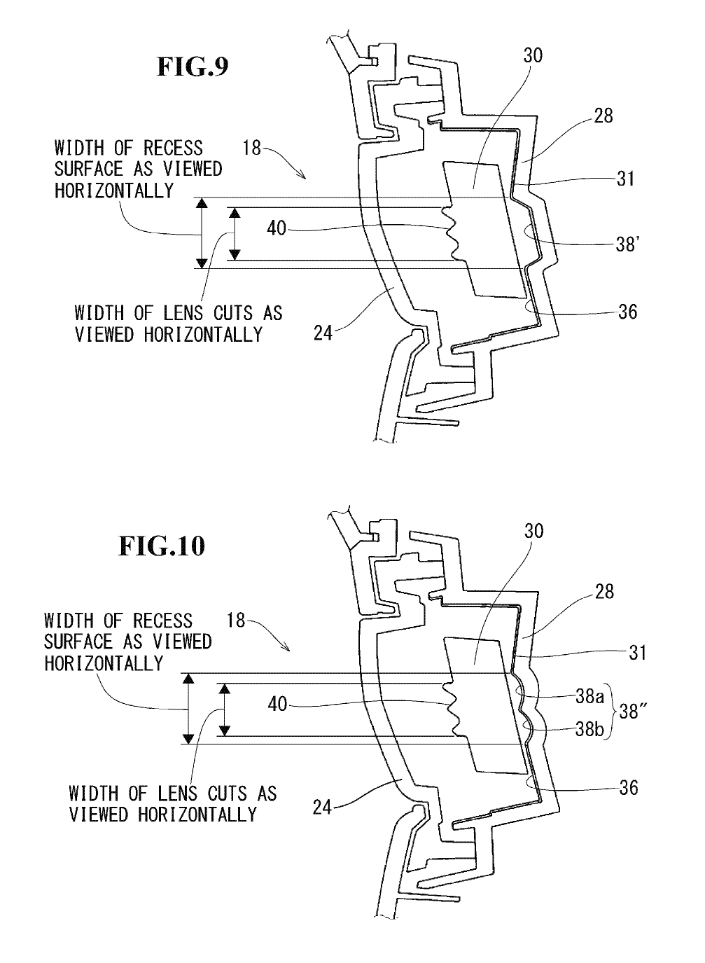

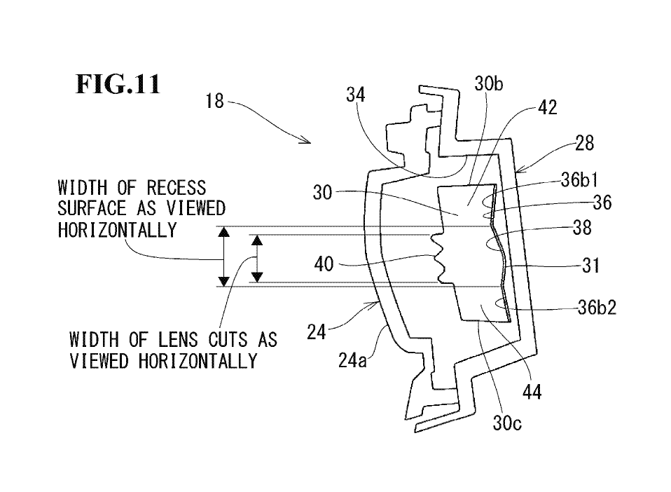

Although in the above-described embodiment, the cut end face shape of the recess surface 38 is curved in a substantially circular arc shape or a substantially parabolic shape, a cut end face of a recess surface according to this invention is not limited to this example. FIGS. 9 and 10 illustrate other examples of the cut end face of the recess surface according to this invention. The structures in FIGS. 9 and 10 are the same as the structure in FIG. 1 except the respective recess surface shapes. A cut end face of a recess surface 38′ in FIG. 9 is a trapezoidal shape. A recess surface 38″ in FIG. 10 is formed of two rows of curved surfaces 38a, 38b.

Also, although in the above embodiment, the LEDs 33, 33, 33 are disposed at three positions in total that are positions in the light entrance 46 of the light-guiding lens 30, the positions facing the auxiliary lens 42, the lens cut 40 and the auxiliary lens 44, respectively, instead of this example, LEDs 33, 33 can be disposed at two positions in total of the light entrance 46, the positions being a position between the auxiliary lens 42 and the lens cuts 40 and a position between the lens cuts 40 and the auxiliary lens 44. Additionally, the number of LEDs used may arbitrarily be set according to, e.g., a necessary amount of light

Also, although in the above embodiment, the mirror surface is formed on a surface of the lamp housing, a position at which the mirror surface is disposed is not limited to this example. In other words, the mirror surface may be formed on, for example, a rear surface of the light-guiding lens. FIG. 11 illustrates an embodiment of this invention in which a mirror surface is formed on a rear surface of a light-guiding lens. In FIG. 11, for parts corresponding to the respective parts in FIG. 1, reference numerals that are the same as those used in FIG. 1 are used. The cut end face structure in FIG. 11 will be described. A front shape of a light-guiding lens 30 is the same as that indicated in the embodiment, and in a center in the upper-lower direction of the light-guiding lens 30, lens cuts 40 are formed. A rear surface of the light-guiding lens 30 is formed in advance in a shape that enables formation of a mirror surface including a recess surface and auxiliary reflective surfaces. A reflective film 31 of a metal such as aluminum or chromium is formed on the entire rear surface of the light-guiding lens 30 by means of, e.g., vapor deposition or plating, and consequently, the mirror surface 36 is configured so as to extend in a direction perpendicular to the sheet. The mirror surface 36 includes a recess surface 38 at a center in an upper-lower direction, and includes auxiliary reflective surfaces 36b1, 36b2 on opposite, upper and lower, sides across the recess surface 38. The recess surface 38 is formed of a surface curved in a substantially circular arc shape or a substantially parabolic shape in the upper-lower direction. Each of the auxiliary reflective surfaces 36b1, 36b2 is formed of a surface that is flat in the upper-lower direction. The upper-side auxiliary reflective surface 36b1 is disposed so as to be inclined upward as viewed from a reference viewpoint position. Also, the lower-side auxiliary reflective surface 36b2 is disposed so as to be inclined downward as view from the reference viewpoint position. As a result, the two auxiliary reflective surfaces 36b1, 36b2 are disposed outward in the upper-lower direction relative to each other. The recess surface 38 is formed at a position behind the lens cuts 40 at which the recess surface 38 overlaps the lens cuts 40 as viewed from the reference viewpoint position, along the lens cuts 40. The recess surface 38 is formed so as to have a width in the upper-lower direction, the width being larger than a width in the upper-lower direction of the lens cuts 40 as viewed from the reference viewpoint position, and the upper-lower direction of the lens cuts 40 is held within the width in the upper-lower direction of the recess surface 38 over an entire area in an extending direction of the lens cut 40, and upper and lower parts of the recess surface 38 appear to slightly protrude above and below the actual lens cuts 40 and have widths that are substantially equal to each other. An image of the lens cuts 40 is enlarged in the upper-lower direction by the recess surface 38 forming a concave mirror. At this time, as viewed from the reference viewpoint position, the reflected image of the lens cuts 40 appears to be held in a substantially entire width in the upper-lower direction of the recess surface 38, and the reflected image of the lens cuts 40 is not seen in the auxiliary reflective surfaces 36b1, 36b2. As a result, as viewed from the reference viewpoint position, an image in which the actual lens cuts 40 and the reflected image thereof passed through the lens cuts 40 overlap each other is seen in a surface of the actual lens cuts 40, and upper and lower parts of the reflected image appear to slightly protrude above and below the actual lens cuts 40 and have widths that are substantially equal to each other. Upon the viewpoint position from which the turn lamp 18 is viewed being moved slightly in the upper-lower direction from the reference viewpoint position, an amount of protrusion of the recess surface 38 on the upper side or the lower side of the actual lens cuts 40 slightly increases along with the movement. However, the state in which the reflected image of the lens cuts 40 appears to be held in the substantially entire width in the upper-lower direction of the recess surface 38 remains unchanged. Therefore, the reflected image of the lens cuts 40 is not seen in the auxiliary reflective surfaces 36b1, 36b2.

Also, although the above embodiment has been described in terms of the case where this invention is applied to a turn lamp to be incorporated in an outer mirror, this invention is applicable also to any of turn lamps for a vehicle for use other than incorporation into an outer mirror.

### REFERENCE SIGNS LIST

10 . . . door mirror for right side of vehicle, 14 mirror body, 18 . . . turn lamp, 24 . . . outer cover, 28 . . . lamp housing, 30 . . . light-guiding lens, 33 . . . LED (light source), 34 . . . recess, 36 . . . mirror surface, 36b1, 36b2 . . . auxiliary reflective surface, 40 . . . lens cut, 38 . . . recess surface, 42, 44 . . . auxiliary lens, 46 . . . light entrance, 48 . . . light exit

1. A turn lamp for a vehicle, the turn lamp including a light-guiding lens, a mirror surface disposed behind the light-guiding lens as viewed from a viewpoint side from which the turn lamp is viewed, and a light source that causes light to enter the light-guiding lens, wherein:
the light-guiding lens includes a lens cut formed so as to extend in a light-guiding direction of the light-guiding lens;
the mirror surface includes a recess surface formed behind the lens cut as viewed from the viewpoint side, along the lens cut; and
the recess surface is formed so as to have a width in a short direction thereof, the width being larger than a width in a short direction of the lens cut, as viewed from the viewpoint side.

2. The turn lamp according to claim 1, wherein:
the light-guiding lens includes an auxiliary lens at each of outer-side positions on opposite sides in the short direction of the lens cut as viewed from the viewpoint side, along the lens cut; and
the auxiliary lens is provided with no lens cut or is provided with a lens cut that causes less attenuation in the light-guiding direction compared to the lens cut.

3. The turn lamp according to claim 2, wherein the auxiliary lens includes a light entrance from which the light from the light source enters, and a light exit from which the light entered from the light entrance and guided through the auxiliary lens is emitted.

4. The turn lamp according to claim 1, wherein:
the mirror surface includes an auxiliary reflective surface disposed so as to extend at each of positions on opposite outer sides in the short direction of the lens cut as viewed from the viewpoint side;
at least a part of the lens cut is disposed on a front side relative to the auxiliary reflective surfaces as viewed from the viewpoint side; and
the auxiliary reflective surfaces include respective surfaces inclined outward relative to each other in the short direction of the lens cut.

5. The turn lamp according to claim 1, wherein the recess surface is a curved surface.

6. The turn lamp according to claim 2, wherein:
the mirror surface includes an auxiliary reflective surface disposed so as to extend at each of positions on opposite outer sides in the short direction of the lens cut as viewed from the viewpoint side;
at least a part of the lens cut is disposed on a front side relative to the auxiliary reflective surfaces as viewed from the viewpoint side; and
the auxiliary reflective surfaces include respective surfaces inclined outward relative to each other in the short direction of the lens cut.

7. The turn lamp according to claim 3, wherein:
the mirror surface includes an auxiliary reflective surface disposed so as to extend at each of positions on opposite outer sides in the short direction of the lens cut as viewed from the viewpoint side;
at least a part of the lens cut is disposed on a front side relative to the auxiliary reflective surfaces as viewed from the viewpoint side; and
the auxiliary reflective surfaces include respective surfaces inclined outward relative to each other in the short direction of the lens cut.

8. The turn lamp according to claim 2, wherein the recess surface is a curved surface.

9. The turn lamp according to claim 3, wherein the recess surface is a curved surface.

10. The turn lamp according to claim 4, wherein the recess surface is a curved surface.

11. The turn lamp according to claim 6, wherein the recess surface is a curved surface.

12. The turn lamp according to claim 7, wherein the recess surface is a curved surface.
